(19) United States
(12) Patent Application Publication
(10) Pub. No.: US 2012/0308282 A1
(43) Pub. Date: Dec. 6, 2012

(54) IMAGING SYSTEM WITH SIMULTANEOUS DUPLEX PRESSURE FIXING

(75) Inventors: Shu CHANG, Pittsford, NY (US); John F. Knapp, Pittsford, NY (US); Christopher Lynn, Wolcott, NY (US)

(73) Assignee: XEROX CORPORATION, Norwalk, CT (US)

(21) Appl. No.: 13/149,227

(22) Filed: May 31, 2011

(51) Int. Cl. G03G 15/20

(52) U.S. Cl. 399/339

(57) ABSTRACT

A system is provided for fixing first and second images on opposite sides of a piece of media. The system has an image forming section for forming at least the first image on the piece of media; and a pressure fixing section for fixing the images to the piece of media. The pressure fixing section has first and second rotating members that do not include a thermal energy source, the second member being located proximate the first member such that a gap exists between the first member and the second member, the gap being for receiving the piece of media, and a force applying device that applies force to at least one of the first member and the second member to apply pressure to the piece of media when the piece of media is located in the gap such that the first and second images are simultaneously fixed to the piece of media by the pressure.

### BACKGROUND

The present disclosure relates generally to fixing of images in image forming devices. More particularly, the present disclosure describes an apparatus, method, and system useful for fixing an image on both sides of a piece of media using pressure fixing techniques.

It is becoming more and more important to build devices with environmentally friendly “Green” enabling technologies. One aspect of green printing is reducing the power consumption in xerographic laser printers. Since most of the power supplied to these printers is consumed by the fuser, it can be important to consider techniques to lower fusing energy per print. Improvements in reducing fuser power such as instant-on only affect standby power, and low-melt toner designs reduce the fuser run temperature, but there is a need to continue to decrease power consumed by the fuser even further.

Pressure fixing offers several advantages over thermal fusing. A printer using pressure fixing can provide an energy reduction of about 90% compared to thermal fusing. Other advantages of pressure fixing include no standby power, instant on, robust fixer rolls that last the life of machine, increased fixer reliability, reduced fixer service costs, fast first copy out time, process speed insensitivity, reusable fixer hardware, reduced emissions, reduced noise, no cooling requirement and no fixer edge-ware issues.

Traditionally, duplex printing is done by inverting and rerouting fused simplex prints back to the imaging station. A second image is then formed on the backside of the paper and subsequently directed to the fusing station again for fixing the second image on paper. This methodology of duplexing involves complicated paper path, reduces the page volume productivity (half the rate of simplex pages), and increases paper jam rates.

In terms of improving the environmental friendliness of printers, duplex printing can significantly reduce paper usage. However, in today's offices, duplex printing is often avoided because of the lower productivity, higher failure rate, and habitual use of simplex printing.

### SUMMARY

The disclosure describes the use of a non-thermal, pressure fixing station as a simultaneous two-sided duplex fixer. The pressure fixing station can have two steel or ceramic rolls that can be, but are not necessarily, identical in surface properties (same or similar materials, surface finish, and surface coating (if required)) but may have different mechanical set ups, such as mounting and engaging mechanisms. The rolls can be designed to provide a different surface finish on each side of the paper, if desired. For example, the rolls can be designed to provide a smooth finish on one side of the paper and a textured finish on the other side of the paper. The pressure fixing station can be used with print engines that have simultaneous two-sided imaging system (single-pass duplex), or with the conventional duplex printing that involves a paper path for inversion and redirection.

The pressure fixing station by itself is very low in power consumption and is environmentally friendly. With a simultaneous duplex imaging station, the paper path can be significantly simplified and productivity can equal simplex printing in pages per minute. The simple paper path can also reduce the failure rate from paper jams.

A system for fixing a first image on a first side of a piece of media and fixing a second image on a second side of the piece of media, the second side being opposite the first side, is provided. The system includes an image forming section for forming at least the first image on the piece of media; and a pressure fixing section that does not include a thermal energy source for fixing the first image to the first side of the piece of media and for fixing the second image to the second side of the piece of media. The pressure fixing section has a first rotating member that does not include a thermal energy source, a second rotating member that does not include a thermal energy source, the second member being located proximate the first member such that a gap exists between the first member and the second member, the gap being for receiving the piece of media, and a force applying device that applies force to at least one of the first member and the second member to apply pressure to the piece of media when the piece of media is located in the gap such that the first and second images are simultaneously fixed to the piece of media by the pressure.

### BRIEF DESCRIPTION OF THE DRAWINGS

The following figures form part of the present specification and are included to further demonstrate certain aspects of the disclosed features and functions, and should not be used to limit or define the disclosed features and functions. Consequently, a more complete understanding of the present embodiments and further features and advantages thereof may be acquired by referring to the following description taken in conjunction with the accompanying drawings, wherein:

FIG. 1 is an exemplary schematic diagram of an imaging system in accordance with embodiments of the disclosure;

FIG. 2 is an exemplary diagram of a duplex pressure fusing section in accordance with embodiments of the disclosure;

FIG. 3 is an exemplary schematic diagram of an imaging system in accordance with embodiments of the disclosure; and

FIG. 4 shows a method in accordance with embodiments of the disclosure.

### DETAILED DESCRIPTION

Illustrative embodiments are described in detail below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of the present disclosure.

The disclosed embodiments may include a system for fixing a first image on a first side of a piece of media and fixing a second image on a second side of the piece of media, the second side being opposite the first side. The system includes an image forming section for forming at least the first image on the piece of media; and a pressure fixing section that does not include a thermal energy source for fixing the first image to the first side of the piece of media and for fixing the second image to the second side of the piece of media. The pressure fixing section has a first rotating member that does not include a thermal energy source, a second rotating member that does not include a thermal energy source, the second member being located proximate the first member such that a gap exists between the first member and the second member, the gap being for receiving the piece of media, and a force applying device that applies force to at least one of the first member and the second member to apply pressure to the piece of media when the piece of media is located in the gap such that the first and second images are simultaneously fixed to the piece of media by the pressure.

The disclosed embodiments may further include a method for fixing a first image on a first side of a piece of media and fixing a second image on a second side of the piece of media, the second side being opposite the first side. The method includes introducing the piece of media to an image forming section; forming at least the first image on the piece of media with the image forming section; and simultaneously fixing the first image to the first side of the piece of media and the second image to the second side of the piece of media with a pressure fixing section, the pressure fixing section having a first rotating member that does not include a thermal energy source and a second rotating member that does not include a thermal energy source, the second member being located proximate the first member such that a gap exists between the first member and the second member, the gap being for receiving the piece of media, the fixing being achieved by simultaneously applying pressure to the first and second sides of the piece of media by applying a force to at least one of the first member and the second member when the piece of media is located in the gap.

This disclosure includes embodiments that use a pressure fixing station that simultaneously fixes images on both sides of a piece of media without using a thermal energy source. These embodiments are very low in power consumption and are environmentally friendly. The absence of a fuser that uses a thermal energy source can also result in a significantly reduction in the instant-on time.

This disclosure includes embodiments that use a pressure fixing station that fixes an image to a piece of media while operating at a reasonable room temperature. Like in other embodiments, the pressure fixing station is the only resident fixing device in the printing system. For the purposes of this application, the term “reasonable room temperature” includes temperatures from about 50° F. to about 100° F. Pressure fixing stations can apply pressure to the toner on the media in the range of about 500 psi to about 5000 psi. As new toners and media are developed, this pressure range may change. In pressure fixing, the toner may or may not go through a phase change as it is subjected to the pressure of the fixing process.

Typical devices that use a thermal energy source (sometimes referred to as “thermal fusers”) operate at temperatures greater than about 212° F. and pressures less than about 200 psi. As new toners and media are developed, this pressure range may change. In thermal fusers, the toner typically goes through a phase change as it is subjected to the heat and pressure of the thermal fusing process.

Some embodiments run the piece of media through a thermal fuser after images have been fixed to both sides of the media by the pressure fixing station. The pressure fixing station fixes the images to the media to a sufficient level to reduce or eliminate smudging or other image problems caused by thermal fusing of a duplex image. This is especially useful when the duplex image is passed through separate thermal fusing steps for each image after both images have been formed on the media.

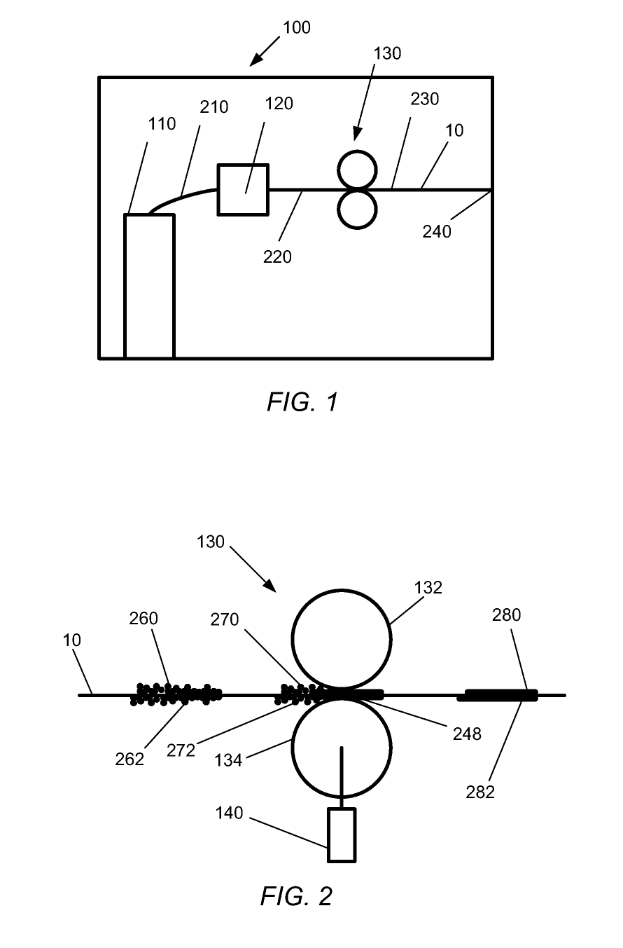

FIG. 1 illustrates an exemplary printing apparatus 100. As used herein, the term “printing apparatus” encompasses any apparatus, such as a digital copier, bookmaking machine, multifunction machine, and the like, that performs a print outputting function for any purpose. Printing apparatus 100 can be used to produce prints from various types of media, such as, for example, coated or uncoated (plain) paper sheets, at different speeds. The media can have various sizes and weights. In embodiments, printing apparatus 100 includes a media feeder 110 connected to an image forming device 120 by a media path 210.

Media feeder 110 is adapted to feed media having various sizes (widths and lengths) and weights to image forming device 120. In an exemplary image forming device 120, toner is developed from one or more developer stations to a charged photoreceptor belt or roll to form toner images on the photoreceptor belt or roll. The toner images are transferred to a piece of media 10 fed through image forming device 120. The media is advanced along a media path 220 to a pressure fixing device 130 to fix the toner images on the media. After the images are fixed to the media 10, media 10 is transported to a media exit 240 along a media path 230.

FIG. 2 illustrates an example of a pressure fixing device in accordance with the disclosure. Pressure fixing device 130 has, in this example, a first rotating member 132 and a second rotating member 134. First rotating member 132 and second rotating member 134 can be, for example, belts or rolls. In the example shown in FIG. 2, both rotating members are shown as rolls. One or both of the first rotating member 132 and the second rotating member 134 can be pressed toward the other by an urging device. FIG. 2 shows an urging device 140 that presses second rotating member 134 toward first rotating member 132. Urging device 140 can be, for example, a hydraulic or pneumatic cylinder, an electric actuator, a spring, or other device that can press one rotating member toward another.

Some embodiments constantly maintain first rotating member 132 and second rotating member 134 in positions at which first rotating member 132 and second rotating member 134 apply pressure on each other. Other embodiments move first rotating member 132 and second rotating member 134 into a position at which first rotating member 132 and second rotating member 134 apply pressure on each other only when a piece of media is present between first rotating member 132 and second rotating member 134.

FIG. 2 illustrates a first image 260 formed on a first side of sheet of media 10 and a second image 262 formed on a second side of sheet of media 10 prior to entering a gap 248 between first rotating member 132 and second rotating member 134. Images 260, 262 are created in image forming device 120 and have not yet been fixed, or fused, to media 10. As images 260, 262 enter gap 248 (shown as images 270, 272), pressure is applied to the images to fix the images to media 10. Fixed images 280, 282 are present on media 10 after they have been subjected to the pressure applied in gap 248 by first rotating member 132 and second rotating member 134.

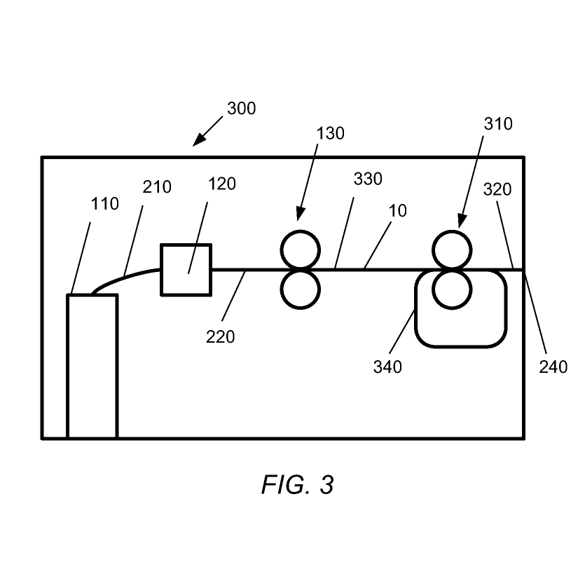

FIG. 3 illustrates an exemplary printing apparatus 300 that is similar to, and shares many features of, printing apparatus 100. Printing apparatus 300 includes a thermal fuser 310 that further fuses the images to media 10. By fixing the images to media 10 with pressure fixing device 130 prior to feeding media, along path 330, to thermal fuser 310, smudging or other image problems caused by thermal fusing of a duplex image can be eliminated or reduced. Images that are thermally fused can be of higher quality than images that are only pressure fixed. Printing apparatus 300 can provide higher quality thermally fused images while preventing the image problems that can result from thermally fusing duplex images and avoiding the complexity of a paper path that fixes the image on the first side of the media prior to forming the image on the second side of the media. A media path 340 is shown schematically that feeds media back into thermal fuser 310. Media path 340 flips media 10 over in between thermal fusing operations if necessary. In FIG. 3, the media is fed to media exit 240 along path 320 after thermal fusing by thermal fuser 310.

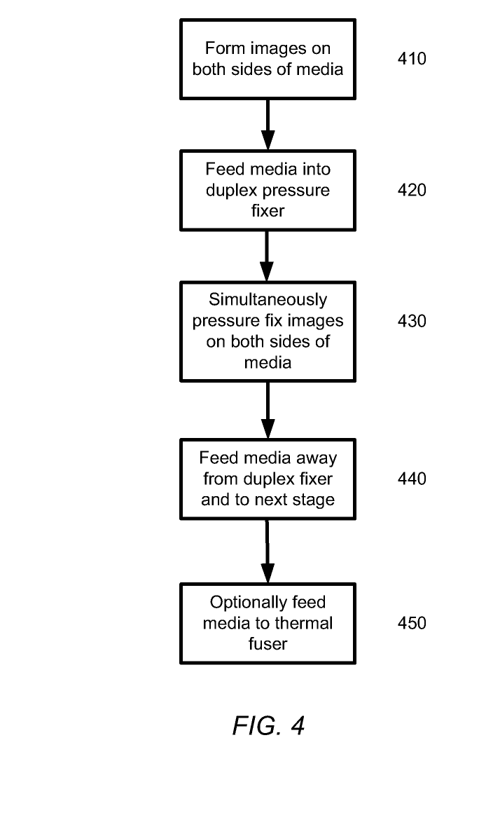

FIG. 4 shows an exemplary method in accordance with embodiments of the disclosure. In 410 an image is formed on both sides of the media by, for example, image forming device 120. In 420, the media is fed into a duplex pressure fixer such as, for example, pressure fixing device 130. In 430 the images are simultaneously fixed with pressure fixing by, for example, pressure fixing device 130. In 440 the media containing the fixed images is fed away from the duplex pressure fixer and on to the next stage of the printing process. In 450 the media is optionally fed to a thermal fuser.

Although the above description is directed toward fuser apparatuses used in xerographic printing, it will be understood that the teachings and claims herein can be applied to any treatment of marking material on a medium. For example, the marking material can be toner, liquid or gel ink, and/or heat- or radiation-curable ink; and/or the medium can utilize certain process conditions, such as temperature, for successful printing. The process conditions, such as heat, pressure and other conditions that are desired for the treatment of ink on media in a given embodiment may be different from the conditions that are suitable for xerographic fusing.

As used herein, the term “printing apparatus” encompasses any apparatus that performs a print outputting function for any purpose. Such apparatuses can include, e.g., a digital copier, bookmaking machine, multifunction machine, and the like. The printing apparatuses can use various types of solid and liquid marking materials, including toner and inks (e.g., liquid inks, gel inks, heat-curable inks and radiation-curable inks), and the like. The printing apparatuses can use various thermal, pressure and other conditions to treat the marking materials and form images on media.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A system for fixing a first image on a first side of a piece of media and fixing a second image on a second side of the piece of media, the second side being opposite the first side, the system comprising:
an image forming section for forming at least the first image on the piece of media; and
a pressure fixing section that does not include a thermal energy source for fixing the first image to the first side of the piece of media and for fixing the second image to the second side of the piece of media, the pressure fixing section having
a first rotating member that does not include a thermal energy source,
a second rotating member that does not include a thermal energy source, the second member being located proximate the first member such that a gap exists between the first member and the second member, the gap being for receiving the piece of media, and
a force applying device that applies force to at least one of the first member and the second member to apply pressure to the piece of media when the piece of media is located in the gap such that the first and second images are simultaneously fixed to the piece of media by the pressure.

2. The system of claim 1, wherein the first member is a roll.

3. The system of claim 2, wherein the second member is a roll.

4. The system of claim 3, wherein the first member has a surface finish and the second member has a surface finish, and
the surface finish of the first member is the same as the surface finish of the second member.

5. The system of claim 4, wherein the pressure fixing section is the only image fixing device used to fix the first and second images to the piece of media.

6. The system of claim 4, wherein the first member and the second member are ceramic.

7. The system of claim 1, wherein the first member has a surface finish and the second member has a surface finish, and
the surface finish of the first member is the same as the surface finish of the second member.

8. The system of claim 1, wherein the pressure fixing section is the only image fixing device used to fix the first and second images to the piece of media.

9. The system of claim 8, wherein the first member and the second member are of identical construction.

10. The system of claim 1, further comprising a thermal fusing section for thermally fixing at least one of the first image and the second image to the piece of media after the at least one of the first image and the second image has been fixed to the piece of media by the pressure fixing section.

11. A method for fixing a first image on a first side of a piece of media and fixing a second image on a second side of the piece of media, the second side being opposite the first side, the method comprising:
introducing the piece of media to an image forming section;
forming at least the first image on the piece of media with the image forming section; and
simultaneously fixing the first image to the first side of the piece of media and the second image to the second side of the piece of media with a pressure fixing section, the pressure fixing section having a first rotating member that does not include a thermal energy source and a second rotating member that does not include a thermal energy source, the second member being located proximate the first member such that a gap exists between the first member and the second member, the gap being for receiving the piece of media, the fixing being achieved by simultaneously applying pressure to the first and second sides of the piece of media by applying a force to at least one of the first member and the second member when the piece of media is located in the gap.

12. The method of claim 11, wherein the first member is a roll.

13. The method of claim 12, wherein the second member is a roll.

14. The method of claim 13, wherein the first member has a surface finish and the second member has a surface finish, and
the surface finish of the first member is the same as the surface finish of the second member.

15. The method of claim 14, wherein the pressure fixing section is the only image fixing device used to fix the first and second images to the piece of media.

16. The method of claim 14, wherein the first member and the second member are ceramic.

17. The method of claim 11, wherein the first member has a surface finish and the second member has a surface finish, and
the surface finish of the first member is the same as the surface finish of the second member.

18. The method of claim 11, wherein the pressure fixing section is the only image fixing device used to fix the first and second images to the piece of media.

19. The method of claim 18, wherein the first member and the second member are of identical construction.

20. The method of claim 11, further comprising thermally fixing at least one of the first image and the second image to the piece of media with a thermal fusing section after the at least one of the first image and the second image has been fixed to the piece of media by the pressure fixing section.
